(19) United States
(12) Patent Application Publication
(10) Pub. No.: US 2004/0142123 A1
(43) Pub. Date: Jul. 22, 2004

(54) Ink-jet recording material

(76) Inventors: Huub Van Aert, Pulderbos (BE); Frank De Voeght, Heist op den Berg (BE); Peter Slabbinck, Knokke-Heist (BE)

Correspondence Address: Joseph T. Guy Ph.D., Nexsen Pruet Jacobs & Pollard LLP, 201 W. McBee Avenue, Greenville, SC, 29603, US

(21) Appl. No.: 10/754,656

(22) Filed: Jan. 9, 2004

Related U.S. Application Data
(60) Provisional application No. 60/444,708, filed on Feb. 4, 2003.

(30) Foreign Application Priority Data
Jan. 10, 2003 (EP) 03100034.2

(51) Int. Cl. B41M 5/00

(52) U.S. Cl. 428/32.1

(57) ABSTRACT

An ink-jet receiving material comprising a support and at least one ink-receiving layer, the ink-jet receiving layer containing an inorganic pigment and a binder, wherein the binder is a water-soluble acetalized vinyl alcohol copolymer, characterized in that the ratio by weight of said inorganic pigment to said binder is at least 4/1. The ink-jet receiving material has excellent coating quality

### CROSS-REFERENCE TO RELATED PATENT APPLICATIONS

This application claims the benefit of U.S. Provisional Application No. 60/444,708 filed Feb. 4, 2003, which is incorporated by reference. In addition, this application claims the benefit of European Application No. 03100034 filed Jan. 10, 2003, which is also incorporated by reference.

### TECHNICAL FIELD

The present invention relates to an improved ink-jet recording material.

### BACKGROUND ART

In the majority of applications printing proceeds by pressure contact of an inkloaded printing form with an ink-receiving material which is usually plain paper. The most frequently used impact printing technique is known as lithographic printing based on the selective acceptance of oleophilic ink on a suitable receptor.

In recent times however so-called non-impact printing systems have to some extent replaced classical pressure-contact printing to some extent for specific applications. A survey is given in the book JOHNSON, Jerome L. Principles of Non Impact Printing. Irvine, Calif. 92715, USA: Palatino Press, 1986.

Among non-impact printing techniques ink-jet printing has become a popular technique because of its simplicity, convenience and low cost. Especially in those instances where a limited edition of the printed matter is needed ink-jet printing has become the technology of choice. A recent survey is given by LE, Hue P. Progress and trends in ink-jet printing technology. Journal of Imaging Science and Technology. 1998, vol.42, no.1, p.49-62.

In ink-jet printing tiny drops of ink fluid are projected directly onto an ink receptor surface without physical contact between the printing device and the receptor. The printing device stores the printing data electronically and controls a mechanism for ejecting the drops image-wise. Printing is accomplished by moving the print head across the paper or vice versa. Early patents on ink-jet printers include U.S. Pat. No. 3,739,393 (MEAD CORP), U.S. Pat. No. 3,805,273 (MEAD CORP) and U.S. Pat. No. 3,891,121 (MEAD CORP).

Jetting of the ink droplets can be performed in several different ways. In a first type of process a continuous droplet stream is created by applying a pressure wave pattern. This process is known as continuous ink-jet printing. In a first embodiment the droplet stream is divided into droplets that are electrostatically charged, deflected and collected, and into droplets that remain uncharged, continue their way undeflected, and form the image. Alternatively, the charged deflected stream forms the image and the uncharged undeflected jet is collected. In this variant of continuous ink-jet printing several jets are deflected to a different degree and thus record the image (multideflection system).

According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink-jet typically include the following ingredients: dyes and/or pigments, water and/or organic solvents, humectants such as glycols, detergents, thickeners, polymeric binders, preservatives, etc. It will be readily understood that the optimal composition of such an ink is dependent on the ink-jetting method used and on the nature of the substrate to be printed. The ink compositions can be roughly divided in:

water based: in which “drying” involves absorption, penetration and evaporation;

oil based: in which “drying” involves absorption and penetration;

solvent based: in which “drying” primarily involve evaporation;

hot melt or phase change: in which the ink vehicle is liquid at the ejection temperature but solid at room temperature, “drying” being the process of solidification;

UV-curable: in which “drying” is a polymerization process.

It is known that the ink-receiving layers in ink-jet recording materials must meet different stringent require:

The ink-receiving layer should have a high ink absorbing capacity, so that the dots will not flow out and will not be expanded more than is necessary to obtain a high optical density.

The ink-receiving layer should have a high ink absorbing speed (short ink drying time) so that the ink droplets will not feather if smeared immediately after applying.

The ink dots that are applied to the ink-receiving layer should be substantially round in shape and smooth at their peripheries. The dot diameter must be constant and accurately controlled.

The receiving layer must be readily wetted so that there is no “puddling”, i.e. coalescence of adjacent ink dots, and an earlier absorbed ink drop should not show any “bleeding”, i.e. overlap with neighbouring or later placed dots.

Transparent ink-jet receiving elements must have a low haze-value and be excellent in transmittance properties.

After being printed the image must have a good resistance regarding water-fastness, light-fastness, and good endurance under severe conditions of temperature and humidity.

The ink-jet receiving element may not show any curl or sticky behaviour if stacked before or after being printed.

The ink-jet receiving element must be able to move smoothly through different types of printers.

All these properties are often in a relation of trade-off. It is difficult to satisfy them all at the same time.

EP 754561 A (CANON KK) discloses a recording medium, comprising a substrate and an ink receiving layer provided on at least one side of the substrate, wherein the ink receiving layer contains polyvinyl acetal resin and alumina hydrate at a ratio by weight within a range of 50/1 to 6/4.

EP 634289 A (CANON KK) discloses an ink-jet recording method for forming an image on a recording medium by ejecting ink droplets through an orifice of a recording head in response to a recording signals, comprising ejecting an ink having a surface tension ranging from 25 to 35 dyn/cm onto a recording medium constituted of a base sheet and a coating layer formed on the base sheet to form an image, the coating layer being selected from (a), (b), and (c) below:

(a) a coating layer mainly composed of polyvinyl alcohol of a saponification degree of from 75 to 98 mol % and a polymerization degree of from 100 to 500, or a derivative thereof,

(b) a coating layer mainly composed of a copolymer of vinylpyrrolidone with a vinyl monomer having a hydrophobic group, and a polyalkylene oxide or a derivative thereof, and

(c) a coating layer mainly composed of an aromatic polyvinylacetal resin, and a polyalkylene oxide or a derivative thereof.

EP 799712 A (CANON KK) discloses a recording medium comprising a substrate and an ink receiving layer provided on at least one side of the substrate, wherein the ink receiving layer comprises a composition or a curing product thereof comprising the following components: a polyvinyl acetal resin (A) having acetal groups, acetyl groups and hydroxyl groups; a monomer (B) having an active energy ray curable ethylenic unsaturated group; and a cationic resin (C); at a weight ratio (B)/(A) within a range of 1/100 to 5/1, and a weight ratio (C)/((A)+(B)) of 0.5/100 to 30/100.

Polyvinyl alcohol and vinyl alcohol copolymers are often used in ink-jet receiving layers as a binder for transparent and porous layers. Specifically for transparent and photograde instant dry receiving layers, which are based on relatively high inorganic pigment/binder ratios to obtain high porosity in the layer, the topographic quality (eveness, roughness) is extremely important to meet the requirements on image quality (gloss, gamut). Therefore the manufacturing process has to be very well controlled.

To obtain uniform layers of high quality at high coating speed it is advantageous to use polymeric binders that give more or less rigid layers after cooling, so that the flow and convection of air can be sufficiently high. Rigid layers can be obtained by gellifying at low temperature or by at least increasing the viscosity of the layer compositions. This process was optimized for gelatin layers in the manufacturing process of the layers of photographic materials.

When using conventional polyvinyl alcohol it is quite difficult to use high coating speeds without introducing too much coating defects. So there is a permanent need in ink-jet receiver technology for another or a modified binder in order to improve the coating quality of the ink-jet media.

### SUMMARY OF THE INVENTION

It is the object of the present invention to provide an ink-jet receiving material with improved coating properties regarding unevenness and coating defects

The above-mentioned advantageous effects are realised by providing an ink-jet receiving material comprising a support and at least one ink-receiving layer, the ink-receiving layer containing an inorganic pigment and a binder, wherein the binder is a water-soluble acetalized vinyl alcohol copolymer, characterized in that the ratio by weight of said inorganic pigment to the binder is at least 4/1.

Further advantages and embodiments of the present invention will become apparent from the following description.

### DETAILED DESCRIPTION OF THE INVENTION

The different layers and particular ingredients of the ink-jet recording medium according to the present invention will now be explained in detail.

Definitions

The term acetalization as used in disclosing the present invention refers to the reaction in which the hydroxy groups of two vinyl alcohol monomer react with an aldehyde to form an acetal group.

The term degree of acetalization as used in disclosing the present invention refers to the weight % of acetalized monomer in the water-soluble vinyl alcohol copolymer.

The term non-ionic aromatic aldehyde as used in disclosing the present invention refers to an aromatic aldehyde without a group capable of ionizing in any medium.

The term water-soluble as used in disclosing the present invention refers to a solubility in water of at least 1% by weight at 25° C.

The term alkyl means all variants possible for each number of carbon atoms in the alkyl group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

The term acyl group as used in disclosing the present invention means —(C═O)aryl and —(C═O)-alkyl groups.

The term saturated aliphatic group as used in disclosing the present invention means saturated straight chain, branched chain and alicyclic hydrocarbon groups.

The term unsaturated aliphatic group as used in disclosing the present invention means straight chain, branched chain and alicyclic hydrocarbon groups which contain at least one double or triple bond.

The term aromatic group as used in disclosing the present invention means an assemblage of cyclic conjugated carbon atoms, which are characterized by large resonance energies, e.g. benzene, naphthalene and anthracene.

The term alicyclic hydrocarbon group as used in disclosing the present invention means an assemblage of cyclic conjugated carbon atoms, which do not form an aromatic group, e.g. cyclohexane.

The term substituted as used in disclosing this invention means that one or more of the carbon atoms and/or that a hydrogen atom of one or more of carbon atoms in an aliphatic group, an aromatic group or an alicyclic hydrocarbon group, are replaced by an oxygen atom, a nitrogen atom, a sulfur atom, a selenium atom or a tellurium atom, or a group containing one or more of these said carbon and hydrogen replacing atoms. Such substituents include hydroxyl groups, ether groups, carboxylic acid groups, ester groups, amide groups and amine groups.

The term heteroaromatic group as used in disclosing the present invention means an aromatic group wherein at least one of the cyclic conjugated carbon atoms is replaced by an oxygen atom, a nitrogen atom, a sulfur atom, a selenium atom or a tellurium atom.

The term heterocyclic group as used in disclosing the present invention means an alicyclic hydrocarbon group wherein at least one of the cyclic conjugated carbon atoms is replaced by an oxygen atom, a nitrogen atom, a sulfur atom, a selenium atom or a tellurium atom.

The term drying as used in disclosing the present invention means any process in which a liquid in contact with a solid medium becomes dry to the touch and includes cooling, gellification, evaporation of a liquid, diffusion into a porous medium and poymerization.

Support

The support for use in the present invention can be chosen from paper type and polymeric type supports well-known from photographic technology. Paper types include plain paper, cast coated paper, polyethylene coated paper and polypropylene coated paper. Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), polyvinyl chloride, polyethers and polysulfonamides.

Other examples of useful high-quality polymeric supports for the present invention include opaque white polyesters and extrusion blends of polyethylene terephthalate and polypropylene. Polyester film supports and especially polyethylene terephthalate are preferred because of their excellent properties of dimensional stability. When such a polyester is used as the support material, a subbing layer may be employed to improve the bonding of the ink-receiving layer to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

Ink-Receiving Layer

It is the gist of the present invention that the at least one ink-receiving layer contains a water-soluble acetalized vinyl alcohol copolymer as a binder.

Preferably the acetalized water-soluble vinyl alcohol copolymer comprises at least one further different comonomer unit besides vinyl alcohol, vinyl acetate and vinyl acetal, with the further different monomer unit being preferably a cationic monomer e.g. diallyldimethyl ammonium chloride, diallyldimethyl ammonium hydroxide or diallyldimethyl ammonium acetate.

Preferably the vinyl alcohol copolymer is a cationic type of polyvinyl alcohol. The acetalization can be carried out in an acid-catalyzed reaction.

Copolymers of vinylalcohol, vinylacetate and a third monomer are preferred as starting materials, with a cationic monomer preferably being the third monomer e.g. diallydimethylammonium chloride. Instead of diallyldimethylammonium chloride any comonomer can be used as third monomer.

The cationic groups on the polyvinylalcohol binder give a good interaction with anionic inks, which results in images with a better image quality showing less bleeding and coalescence of the anionic inks. The cationic groups not only interact well with anionic inks but surprisingly also have an influence on the crosslinking rate with crosslinkers like boric acid. It appears that conventional polyvinylalcohols modified with an aromatic aldehyde crosslink much faster with boric acid as compared to the corresponding cationic polyvinylalcohols.

A commercially available cationic vinyl alcohol copolymer can be used as starting compound. Preferably, a vinyl alcohol copolymer modified with diallyldimethyl ammonium chloride (DADMAC) comonomer units is used. Such vinyl alcohol copolymers are commercially available via the company Nippon Gohsei. Other suitable cationic vinyl alcohol copolymer grades are copolymers of methacrylamido propyl trimethylammonium chloride as available from the company Kuraray (e.g. trademarks POVAL CM318, POVAL C506 and POVAL C118).

A water-soluble acetalized vinyl alcohol copolymer, as used in the ink-jet receiving layer, according to the present invention, can be prepared via the following sequence of steps:

1) copolymerisation of vinylacetate with a different monomer,

2) hydrolyis of the modified vinylacetate copolymer,

3) acetalization of the modified vinyl alcohol copolymer with an aldehyde.

When using a cationic modified vinyl alcohol copolymer as starting materials for the acetalisation, GOHSEFIMER K210, which is a copolymer of vinylacetate, vinylalcohol and diallyldimethylammonium chloride, is suitable for this purpose (scheme 1).

Scheme 1: Modification of a copolymer of vinyl alcohol, vinylacetate and diallyldimethyl ammonium chloride with benzaldehyde.

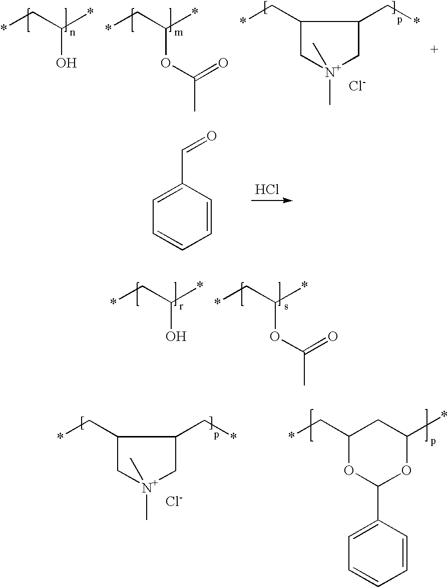

Since the acetalization is done under acidic conditions the vinyl alcohol-vinyl acetate copolymer can hydrolyse further, yielding a copolymer with a higher degree of hydrolysis. The chloride and acetate ions are partially or completely removed by means of an ion-exchange resin. The preferably used copolymer of diallyldimethylammonium chloride can therefore also be partially converted to a cationic polymer with hydroxyl or acetate counter-ions.

Aldehydes suitable for acetalizing the vinyl alcohol copolymer to produce the water-soluble acetalized vinyl alcohol used in the ink-receiving layer, according to the present invention, include aliphatic saturated aldehydes such as formaldehyde, acetaldehyde, propionaldehyde, butyl aldehyde, isobutyl aldehyde, isopropyl aldehyde, valeraldehyde, isovaleraldehyde, and the like; heterocyclic aldehydes such as furfural and the like; aliphatic unsaturated aldehydes such as acrolein, crotonaldehyde, propriolaldehyde, hexenal, heptenal, and the like; aliphatic dialdehydes such as glyoxal, succindialdehyde, glutardialdehyde, adipodialdehyde, piperic dialdehyde, suberic dialdehyde, sebacic dialdehyde, and the like; and aromatic aldehydes, such as benzaldehyde, o-, m- or p-tolualdehyde, benzyl aldehyde, salicylaldehyde, cinnamaldehyde, α- or β-naphthaldehyde, with the aromatic aldehydes being particularly preferable.

In the present invention the vinyl alcohol copolymer is modified with a sufficiently low content of aldehyde, so that the copolymer remains water-soluble.

Preferably the degree of acetalization in said water-soluble vinyl alcohol copolymer is at most 15% by weight of aldehyde with respect to the vinyl alcohol copolymer acetalized.

Particularly preferably the degree of acetalization in said water-soluble vinyl alcohol copolymer is between 3 and 8% by weight of aldehyde with respect to the vinyl alcohol copolymer acetalized.

Preferably the water-soluble acetalized vinyl alcohol copolymer is acetalized by means of a non-ionic aromatic aldehyde. Preferred aromatic aldehydes which can be used include benzaldehyde and phenylacetaldehyde. Modification of vinyl alcohol copolymer with benzaldehyde (scheme 2) and phenylacetaldehyde (scheme 3) yields an acetalized vinyl alcohol copolymer.

Scheme 2: Modification of conventional vinyl alcohol copolymer with benzaldehyde.

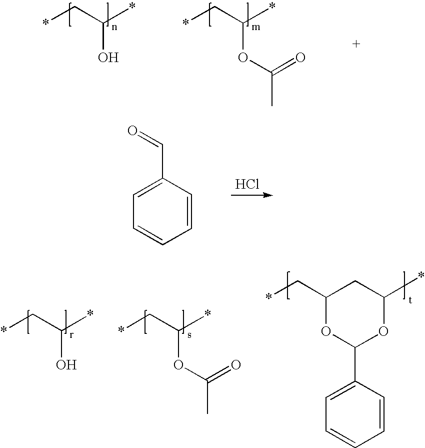

Scheme 3: Modification of conventional vinyl alcohol copolymer with phenylacetaldehyde.

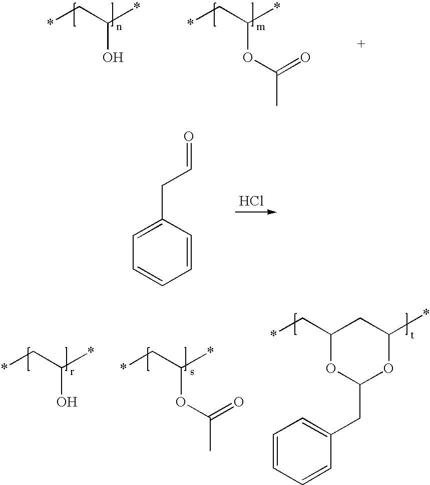

Particularly preferably the vinyl alcohol copolymer is modified by acetalization with a low content of a non-ionic aromatic aldehyde. This modification gives sufficient viscosity increase at low temperatures to give a more stable coating during the drying process.

Modification of a vinyl alcohol copolymer with a benzaldehyde content above 15% by weight with respect to the vinyl alcohol copolymer, for example, renders the resulting copolymer insoluble and only soluble when alcohols are added to the modified binder. The presence of alcohols results in undesirable emission of alcohols during the coating of ink-jet receiving layers.

Preferably the acetalized water-soluble vinyl alcohol copolymer is a vinyl alcohol copolymer acetalized with a non-ionic aromatic aldehyde to a degree of acetalization of at most 15% by weight of non-ionic aromatic aldehyde with respect to the solid vinyl alcohol copolymer.

Particularly preferably the acetalized water-soluble vinyl alcohol copolymer is a vinyl alcohol copolymer acetalized with a non-ionic aromatic aldehyde to a degree of acetalization of between 3 and 8% by weight of non-ionic aromatic aldehyde with respect to the solid vinyl alcohol copolymer.

The acetalized vinyl alcohol copolymer used in the ink-jet receiving layers, according to the present invention, is water-soluble. This has the advantage that the acetalized vinyl alcohol copolymer is suitable as a binding agent for inorganic pigments, such as silica or alumina. JP 11116620 A (SEKISUI CHEM CO LTD) and JP 11116619 A (SEKISUI CHEM CO LTD) disclose the use of modified vinyl alcohol copolymers in ink-jet coatings. These copolymers, such as S LEC KX-1 commercially available from Sekisui, are, however, not water-soluble. Furthermore Sekisui describes water-insoluble polymers based on acetalised vinyl alcohol copolymer, which are described as microgels. The microgels are prepared by using a very high content of aromatic aldehyde (e.g. as in the Japanese patent JP 10237258 A (SEKISUI CHEM CO LTD)) or the use of a mixture of an aromatic aldehyde and formaldehyde.

Pigment

Apart from the binder, being a water-soluble acetalized vinyl alcohol copolymer, the at least one ink-receiving layer according to the present invention is preferably a porous layer and hence preferably contains a pigment. An inorganic pigment is preferably used, which can be chosen from neutral, anionic and cationic pigment types. Useful pigments include e.g. silica, talc, clay, hydrotalcite, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, alumina hydrate such as boehmite, pseudo boehmite, aluminum oxide, zirconium oxide or mixed oxides.

Preferably, the inorganic pigment is selected from the group consiting of silica, alumina and boehmite.

Particularly preferably, the pigment is a cationic type pigment selected from alumina hydrates, aluminum oxides, aluminum hydroxides, aluminum silicates, and cationically modified silicas.

A preferred type of alumina hydrate is crystalline boehmite, or γ-AlO(OH). Useful types of boehmite include, in powder form, DISPERAL, DISPERAL HP14 and DISPERAL 40 from Sasol, MARTOXIN VPP2000-2 and GL-3 from Martinswerk GmbH.; liquid boehmite alumina systems, e.g. DISPAL 23N4-20, DISPAL 14N-25, DISPERAL AL25 from Sasol, boehmite dispersions BACASOL 2C and BACASOL 3C from Alcan. Patents disclosing the use of alumina hydrate in ink-jet receiving layers EP 500021 A (ASAHI GLASS), EP 634286 A (ASAHI GLASS), U.S. Pat. No. 5,624,428 (KIMBERLY CLARK), EP 742108 A (ASAHI GLASS), U.S. Pat. No. 6,238,047 (ASAHI GLASS), EP 622244 A (CANON KK), EP 810101 A (CANON KK), etc.

Useful cationic aluminum oxide (alumina) types include α-Al₂O₃ types, such as NORTON E700, available from Saint-Gobain Ceramics & Plastics, Inc, and γ-Al₂O₃ types, such as ALUMINUM OXID C from Degussa; other aluminum oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 trademark from Cabot, CATALOX GRADES and CATAPAL GRADES from from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco.

Other useful cationic inorganic pigments include aluminum trihydroxides such as Bayerite, or α-Al(OH)₃, such as PLURAL BT, available from Sasol, and Gibbsite, or γ-Al(OH)₃, such as MARTINAL grades from Martinswerk GmbH, MARTIFIN grades, such as MARTIFIN OL104, MARTIFIN OL 107 and MARTIFIN OL111 from Martinswerk GmbH, MICRAL grades, such as MICRAL 1440, MICRAL 1500; MICRAL 632; MICRAL 855; MICRAL 916; MICRAL 932; MICRAL 932CM; MICRAL 9400 from JM Huber company; HIGILITE grades, e.g. HIGILITE H42 or HIGILITE H43M from Showa Denka K. K., HYDRAL COATES grades from Alcoa Co., such as HYDRAL COAT 2, 5, and 7, HYDRAL PGA and HYDRAL 710.

Another useful type of cationic pigment is zirconium oxide such as NALCO OOSS008 trademark of ONDEO Nalco, acetate stabilized ZrO₂, ZR20/20, ZR50/20, ZR100/20 and ZRYS4 trademarks from Nyacol Nano Technologies.

Useful mixed oxides are SIRAL grades from Sasol, colloidal metal oxides from Nalco such as Nalco 1056, Nalco TX10496, Nalco TX11678.

Another preferred type of inorganic pigment is silica, which can be used as such in its anionic form or after cationic modification. Silica as pigment in ink-receiving elements is disclosed in numerous old and recent patents, e.g. U.S. Pat. No. 4,892,591 (MIZUSAWA INDUSTRIAL CHEM), U.S. Pat. No. 4,902,568 (CANON KK), EP 373573 A (CIBA GEIGY), EP 423829 A (OJI PAPER), EP 487350 A (XEROX), EP 493100 A (SANYO KOKUSAKU PULP), EP 514633 A (SCHOELLER FELIX JUN PAPIER), etc. The silica can be chosen from different types, such as crystalline silica, amorphous silica, precipitated silica, fumed silica, silica gel, spherical and non-spherical silica. The silica may contain minor amounts of metal oxides from the group Al, Zr, Ti. Useful types include AEROSIL OX50 (BET surface area 50±15 m²/g, average primary particle size 40 nm, SiO₂ content >99.8%, Al₂O₃ content <0.08%), AEROSIL MOX170 (BET surface area 170 m²/g, average primary particle size 15 nm, SiO₂ content >98.3%, Al₂O₃ content 0.3-1.3%), AEROSIL MOX80 (BET surface area 80±20 m²/g, average primary particle size 30 nm, SiO₂ content >98.3%, Al₂O₃ content 0.3-1.3%), or other hydrophilic AEROSIL grades available from Degussa-Hüls AG, which may give aqueous dispersions with a small average particle size (<500 nm).

Cationically modified silica is disclosed in JP 60219084 (MITSUBISHI SEISHI K K) and JP 60224580 (MITSUBISHI SEISHI K K) and can be prepared by following methods, without meaning to be limitative:

1. By subjecting silica to a surface treatment with an inorganic cationic compound such as particular metal oxides and oxyhydroxides, e.g. aluminum oxides, and alumina hydrates such as boehmite and pseudo-boehmite; a useful cationic inorganic compound to modify silica is pseudo-boehmite. Pseudo-boehmite is also called boehmite gel and is fine particulate alumina hydrate having a needle form. The composition thereof is generally represented by Al₂O₃.1.5-2H₂O and differs from that of crystalline boehmite;

2. by subjecting silica to a surface treatment with an organic compound having both an amino group or quaternary ammonium group thereof or a quaternary phosphonium group, and a functional group having reactivity to a silanol group on the surface of silica, such as aminoalkoxysilane or aminoalkyl glycidyl ether or isopropanol amine;

3. by polymerisation of a cationic or amino functional monomer in the presence of a silica.

In an alternative embodiment the pigment may be chosen from organic particles such as polystyrene, polymethyl methacrylate, silicones, melamine-formaldehyde condensation polymers, urea-formaldehyde condensation polymers, polyesters and polyamides. Mixtures of inorganic and organic pigments can be used. However, most preferably the pigment is an inorganic pigment.

The pigment must be present in a sufficient coverage in order to render the ink-receiving layer sufficiently porous that inks are rapidly dry to the touch upon contacting with the ink-jet receiving layer.

For obtaining glossy ink-receiving layers the particle size of the pigment should preferably be smaller than 500 nm. In order to obtain a porous glossy layer which can serve as an ink-receiving layer for fast ink uptake it has been surprisingly found that the pigment/binder ratio should be at least 4. To achieve a sufficient porosity of the coating for fast ink uptake the pore volume of these highly pigmented coatings should be higher than 0.1 ml/g of coated solids. This pore volume can be measured by gas adsorption (nitrogen) or by mercury diffusion.

The ink-receiving layer may be just a single layer but, alternatively, it may be composed of a double layer or even of a multiple layer assemblage. In the latter cases the pigment may be present in one of the layers, in several of the layers or in all of the layers, which may be coated sequentially or simultaneously.

Cationic Mordant

Apart from the essential ingredients described above a cationic substance acting as mordant may be present in the ink-receiving layer. Such substances increase the capacity of the layer for fixing and holding the dye of the ink droplets. A particularly suitable compound is a poly(diallyldimethylammonium chloride) (poly(DADMAC). These compounds are commercially available from, for example, Aldrich, Nalco, CIBA, Nitto Boseki Co., Clariant, BASF and EKA Chemicals.

Other useful cationic compounds include DADMAC copolymers such as copolymers of DADMAC with acrylamide, e.g NALCO 1470 trade mark of ONDEO Nalco or PAS-J-81, trademark of Nitto Boseki Co., such as copolymers of DADMAC with acrylates, such as Nalco 8190, trademark of ONDEO Nalco; copolymers of DADMAC with SO₂, such as PAS-A-1 or PAS-92, trademarks of Nitto Boseki Co., copolymer of DADMAC with maleic acid, e.g. PAS-410, trademark of Nitto Boseki Co., copolymer of DADMAC with diallyl(3-chloro-2hydroxypropyl)amine hydrochloride, eg. PAS-880, trademark of Nitto Boseki Co., dimethylamine-epichlorohydrine copolymers, e.g. Nalco 7135, trademark of ONDEO Nalco or POLYFIX 700, trade name of Showa High Polymer Co.; other POLYFIX grades which could be used are POLYFIX 601, POLYFIX 301, POLYFIX 301 A, POLYFIX 250WS, and POLYFIX 3000; NEOFIX E-117, trade name of Nicca Chemical Co., a polyoxyalkylene polyamine dicyanodiamine, and REDIFLOC 4150, trade name of EKA Chemicals, a polyamine; MADAME (methacrylatedimethylaminoethyl=dimethylaminoethyl methacrylate) or MADQUAT (methacryloxyethyltrimethylammonium chloride) modified polymers, e.g. ROHAGIT KL280, ROHAGIT 210, ROHAGIT SL144, PLEX 4739L, PLEX 3073 from Rohm, DIAFLOC KP155 and other DIAFLOC products from Diafloc Co., and BMB 1305 and other BMB products from EKA chemicals; cationic epichlorohydrin adducts such as POLYCUP 171 and POLYCUP 172, trade names from Hercules Co.; from Cytec industries: CYPRO products, e.g. CYPRO 514/515/516, SUPERFLOC 507/521/567; cationic acrylic polymers, such as ALCOSTAT 567, trademark of CIBA, cationic cellulose derivatives such as CELQUAT L-2OO, H-1OO, SC-240C, SC-230M, trade names of Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LUPASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; phosphonium compounds such as disclosed in EP 609930 A (AGFA GEVAERT NV) and other cationic polymers such as NEOFIX RD-5, trademark of Nicca Chemical Co.

The ink-receiving layer(s), and an optional auxiliary layer, such as a backing layer for anti-curl purposes, or an extra protective layer, may further contain well-known conventional ingredients, such as hardening agents, plasticizers, whitening agents, matting agents and surfactants serving as coating aids.

Surfactants

Surfactants may be incorporated in the layers of the ink-jet receiving material of the present invention. They can be any of the cationic, anionic, amphoteric, and non-ionic ones as described in JP 62280068 A (CANON INC).

Examples of the suitable surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfoacid salts, sulfonated oils, alkylsulfonic acid salts, alkylether sulfonic acid salts, alkylallylethersulfonic acid salts, alkylamidesulfonic acid salts, alkylphosphoric acid salts, alkyletheracid salts, alkylallyletherphosphoric acid salts, alkyl and alkylallylpolyoxyethylene ethers, alkylallylformaldehyde condensed acid salts, alkylallylethersulfonic acid salts, alkylamideacid salts, alkylphosphoric acid salts, alkyletherphosphoric acid salts, alkylalacid salts, alkyl and alkylallylpolyoxyethylene ethers, alkylallylformaldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugaresters, fluoro C₂-C₁₀ alkylcarboxylic acids, disodium N-perfluorooctanesulfonyl glutamate, sodium 3-(fluoro-C₆-C₁₁-alkyloxy)-1-C₃-C₄ alkyl sulfonates, sodium 3-(ω-fluoro-C₆-C₈-alkanoy-N-ethylamino)-1-propanelsulfonates, N-[3-(perfluoroctanesulfonamide)-propyl]-N,N-dimethyl-N-carboxymethylene ammonium betaine, fluoro-C₁₁-C₂₀ alkylcarboxylic acids, perfluoro-C₇-C₁₃-alkyl-carboxylic acids, perfluorooctane sulfonic acid diethanolamide, Li, K and Na perfluoro-C₄-C₁₂-alkyl sulfonates, N-propyl-N-(2-hydroxyethyl)perfluorooctane sulfonamide, perfluoro-C₆-C₁₀-alkylsulfonamide-propyl-sulfonyl-glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-dimoniumchloride phosphate, palmityl trimethylammonium chloride, and cetyltrimethylammonium bromide.

Especially useful are the fluorocarbon surfactants as described in e.g. U.S. Pat. No. 4,781,895 (SPECTOR DONALD, having a structure of: F(CF₂)₄CH₂CH₂SCH₂CH₂N⁺R₃X⁺ wherein R is a hydrogen or an alkyl group; and in U.S. Pat. No. 5,084,340 (EASTMAN KODAK), having a structure of: CF₃(CF₂)ₘCH₂CH₂O(CH₂CH₂O)ₙR wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2%, preferably in the range of 0.4 to 1.5% and is most preferably 0.75% by weight based on the total dry weight of the layer.

Crosslinking Agent

The ink-receiving layer(s) and the optional auxiliary layer(s) preferably further contain a crosslinking agent. There are numerous known crosslinking agents that will crosslink film-forming binders, including formaldehyde and free dialdehydes, such as succinaldehyde and glutaraldehyde; blocked dialdehydes; active esters; sulfonate esters; active halogen compounds; isocyanate or blocked isocyanates; polyfunctional isocyanates; melamine derivatives; s-triazines and diazines; epoxides; active olefins having two or more active bonds; carbodiimides; zirconium complexes, e.g. BACOTE 20, ZIRMEL 1000 or zirconium acetate, trademarks of MEL Chemicals; titanium complexes, such as TYZOR grades from DuPont; isoxazolium salts substituted in the 3-position; esters of 2-alkoxy-N-carboxy-dihydroquinoline; N-carbamoylpyridinium salts; hardeners of mixed function, such as halogen-substituted aldehyde acids (e.g. mucochloric and mucobromic acids); onium substituted acroleins; vinyl sulfones; polymeric hardeners, such as dialdehyde starches and copoly(acroleinmethacrylic acid), oxazoline functional polymers, e.g. EPOCROS WS-500, and EPOCROS K-1000 series, and maleic anhydride copolymers, e.g. GANTREZ AN119; and boric acid, boric acid salts and borates.

For the practice of this invention boric acid is a preferred crosslinker.

Plasticizer

The ink-receiving layer and the optional auxiliary layer(s) may also comprise a plasticizer such as ethylene glycol, diethylene glycol, propylene glycol, polyethylene glycol, glycerol monomethylether, glycerol monochlorohydrin, ethylene carbonate, propylene carbonate, urea phosphate, triphenylphosphate, glycerolpropylene glycol monostearate, tetramethylene sulfone, n-methyl-2pyrrolidone, n-vinyl-2-pyrrolidone.

Coating Method

The different layers can be coated onto support by any conventional coating technique, such as dip coating, knife coating, extrusion coating, spin coating, slide hopper coating and curtain coating.

### EXAMPLES

Synthesis Examples

Synthetic Procedure for Polymer 1, i.e. GOHSEFIMER K210 Modified with 5 Weight % Benzaldehyde Relative to the Vinyl Alcohol Copolymer Solid Mass.

45,1 kg of a 9,8 weight % aqueous solution of GOHSEFIMER K210, trademark of Nippon Gohsei, was added to a 80 L oil-heated jacketed reactor. The reactor was subsequently flushed with nitrogen and stirred at room temperature at 300 rpm during 15 minutes. 4602 g of aqueous 1N HCl was added to the reactor and the polymer solution was stirred for an additional 5 minutes. Subsequently 221 grams of benzaldehyde was added in 30 minutes. The reactor was stirred during one hour at room temperature. Afterwards the reactor was heated to 70° C. and kept at this temperature for 4 hours. The warm aqueous solution was neutralised using 11.7 L of an alkaline ion-exchange resin (alkaline treated LEWATIT M600 MB). The ion-exchange resin was filtered off and the hot filtrate was allowed to cool to room temperature. Bronidox K was added as biocide (200 ppm).

Synthetic Procedure for Polymer 2 i.e. GOHSEFIMER K210 Modified with 3.75% Benzaldehyde Relative to the Vinyl Alcohol Copolymer Solid Mass.

45,1 kg of a 9,8 weight % aqueous solution of GOHSEFIMER K210, trademark of Nippon Gohsei, was added to a 80 L oil-heated jacketed reactor. The reactor was subsequently flushed with nitrogen and stirred at room temperature at 300 rpm during 15 minutes. 4602 g of aqueous 1N HCl was added to the reactor and the polymer solution was stirred for an additional 5 minutes. Subsequently 165.8 g of benzaldehyde was added in 30 minutes. The reactor was stirred during one hour at room temperature. Afterwards the reactor was heated to 70° C. and kept at this temperature for 4 hours. The warm aqueous solution was neutralised using 11.7 L of an alkaline ionexchange resin (alkaline treated LEWATIT M600 MB). The ionexchange resin was filtered off and the hot filtrate was allowed to cool to room temperature. Bronidox K was added as biocide (200 ppm).

Synthetic Procedure for Polymer 3: i.e. GOHSEFIMER K210 Modified with 4.25 Weight % Phenylacetaldehyde Relative to the Vinyl Alcohol Copolymer Solid Mass.

4315 grams of a 9,85 weight % aqueous solution of GOHSEFIMER K210, trademark of Nippon Gohsei, was added to a 8 L oil-heated jacketed reactor. The reactor was subsequently flushed with nitrogen and stirred at room temperature at 150 rpm during 15 minutes. 43.65 g of aqueous 1N HCl was added to the reactor and the polymer solution was stirred for an additional 5 minutes. Subsequently 21.25 g of phenylacetaldehyde (85% pure) was added in 30 minutes. The stirring speed was raised to 170 rpm to obtain a homogeneous solution. The reactor was stirred during one hour at room temperature. Afterwards the reactor was heated to 70° C. and kept at this temperature for 4 hours. The warm aqueous solution was neutralised using 1400 ml of an alkaline ion-exchange resin (alkaline treated LEWATIT M600 MB) until the pH=9.2. The ion-exchange resin was filtered off using a Büchner funnel with 25 μm nylon filter and the hot filtrate was allowed to cool to room temperature. Bronidox K was added as biocide (400 ppm).

Synthetic Procedure for Polymer 4: i.e. MOWIOL 8/88 Modified with 3.75 Weight % Benzaldehyde Relative to the Vinyl Alcohol Copolymer Solid Mass.

4413.8 grams of a 14,16 weight % aqueous solution of MOWIOL 8/88, trademark of Kuraray Europe (former Clariant), was added to a 8 L oil-heated jacketed reactor. The reactor was subsequently flushed with nitrogen and stirred at room temperature at 150 rpm during 15 minutes. 64.19 g of aqueous 1N HCl was added to the reactor and the polymer solution was stirred for an additional 5 minutes. Subsequently 23.92 g of benzaldehyde (98% pure) was added in 30 minutes. The reactor was stirred during one hour at room temperature. Afterwards the reactor was heated to 70° C. and kept at this temperature for 4 hours. The warm aqueous solution was neutralised using 2580 ml of an alkaline ion-exchange resin (alkaline treated LEWATIT M600 MB). The ion-exchange resin was filtered off using a Büchner funnel with 25 μm nylon filter and the hot filtrate was allowed to cool to room temperature. Bronidox K was added as biocide (400 ppm). The prepared solution has a pH of 6.75.

Synthetic Procedure for Polymer 5: i.e. MOWIOL 8/88 Modified with 4.25 Weight % Phenylacetaldehyde Related to the Vinyl Alcohol Copolymer Solid Mass.

4379,8 grams of a 14,27 weight % aqueous solution of MOWIOL 8/88, trademark of Kuraray Europe (former Clariant), was added to a 8 L oil-heated jacketed reactor. The reactor was subsequently flushed with nitrogen and stirred at room temperature at 150 rpm during 15 minutes. 64,19 g of aqueous 1N HCl was added to the reactor and the polymer solution was stirred for an additional 5 minutes. Subsequently 31.25 g of phenylacetaldehyde (85% pure) was added in 30 minutes. The reactor was stirred during one hour at room temperature. Afterwards the reactor was heated to 70° C. and kept at this temperature for 4 hours. The warm aqueous solution was neutralised using 2050 ml of an alkaline ion-exchange resin (alkaline treated LEWATIT M600 MB). The ion-exchange resin was filtered off using a Büchner funnel with 25 μm nylon filter and the hot filtrate was allowed to cool to room temperature. Bronidox K was added as biocide (400 ppm). The prepared solution has a pH of 7.35.

Evaluation Invention Example

Ink-receiving layers, based on boehmite and a water-soluble acetalized vinyl alcohol copolymer, GOHSEFIMER K210 modified with 3.75% of benzaldehyde relative to the vinyl alcohol copolymer solid mass, as principal ingredients, and crosslinked with boric acid, were coated as a triple layer pack by means of standard coating device on a transparent 100 μm thick polyester support. The layer composition is summarized in Table 1.

TABLE 1

| | Weight | |
|---|---|---|
| | (g/m²) | Wet thickness (μm) |
| Adhesion layer | | |
| GOHSEFIMER K210 | 0.55 | 15 |
| Silica AEROSIL | 0.277 | |
| Pseudoboehmite | 0.053 | |
| Receiving layer I | | |
| acetalized GOHSEFIMER K210 | 2.1 | 107 |
| Boric acid | 0.31 | |
| Boehmite | 26.3 | |
| Receiving layer II | | |
| acetalized GOHSEFIMER K210 | 0.36 | 22 |
| Boric acid | 0.064 | |
| Boehmite | 5.5 | |

The assemblage of coated layers having a total thickness of 144 μm were subjected to an online drying process to evaporate the water. The drying process consisted of the following two essential steps:

Step 1: conditioning at a low temperature with moderate airflow (<10 m/s) so that the layer temperature Tw reaches a value as low as 10° C. during 20 seconds;

Step 2: a drying step of about 130 seconds at high airflow (up to 20 m/s) so that the layer temperature reaches a value up to 22° C.

Visual inspection of the coated receiving layer assemblage showed that the layer assemblage of the evaluation invention example according to the present invention exhibited excellent coating quality.

Evaluation Comparative Example

Ink-receiving layers, based on boehmite and a water-soluble vinyl alcohol copolymer, GOHSEFIMER K210, as principal ingredients, and crosslinked with boric acid, were coated as a triple layer pack by means of standard coating device on a transparent 100 μm thick polyester support. The layer composition is summarized in Table 2.

TABLE 2

| | Weight | |
|---|---|---|
| | (g/m²) | Wet thickness (μm) |
| Adhesion layer | | |
| GOHSEFIMER K210 | 0.55 | 15 |
| Silica AEROSIL | 0.277 | |
| Pseudoboehmite | 0.053 | |
| Receiving layer I | | |
| GOHSEFIMER K210 | 2.1 | 107 |
| Boric acid | 0.31 | |
| Boehmite | 26.3 | |
| Receiving layer II | | |
| GOHSEFIMER K210 | 0.36 | 22 |
| Boric acid | 0.064 | |
| Boehmite | 5.5 | |

The assemblage of coated layers having a total thickness of 144 μm were subjected to the same online drying process as the evaluation invention example.

Visual inspection of the coated receiving layer assemblage showed that the layer assemblage of the evaluation comparative example outside the scope of the present invention exhibited unacceptable coating quality regarding unevenness, whereas that of the evaluation invention example exhibited an excellent coating quality.

Having described in detail preferred embodiments of the current invention, it will now be apparent to those skilled in the art that numerous modifications can be made therein without departing from the scope of the invention as defined in the following claims.

1. An ink-jet receiving material comprising a support and at least one ink-receiving layer, said ink-receiving layer containing an inorganic pigment and a binder, wherein the binder is an acetalized water-soluble vinyl alcohol copolymer, characterized in that the ratio by weight of said inorganic pigment to said binder is at least 4/1.

2. An ink-jet receiving material according to claim 1, wherein said acetalized water-soluble vinyl alcohol copolymer comprises at least one further different comonomer unit besides vinyl alcohol, vinyl acetate and vinyl acetal.

3. An ink-jet receiving material according to claim 2, wherein said further different comonomer unit is a cationic comonomer.

4. An ink-jet receiving material according to claim 3, wherein said cationic comonomer unit is diallyldimethyl ammonium chloride, diallyldimethyl ammonium hydroxide, or diallyldimethyl ammonium acetate.

5. An ink-jet receiving material according to any one of claims 1, wherein the degree of acetalization in said water-soluble vinyl alcohol copolymer is at most 15% by weight of aldehyde with respect to the vinyl alcohol copolymer acetalized.

6. An ink-jet receiving material according to one of claims 1, wherein the degree of acetalization in said water-soluble vinyl alcohol copolymer is between 3 and 8% by weight of aldehyde with respect to the vinyl alcohol copolymer acetalized.

7. An ink-jet receiving material according to any one of claims 1, wherein said water-soluble acetalized vinyl alcohol copolymer is acetalized by means of a non-ionic aromatic aldehyde.

8. An ink-jet receiving material according to claim 7, wherein said non-ionic aromatic aldehyde is benzaldehyde.

9. An ink-jet receiving material according to claim 7, wherein said non-ionic aromatic aldehyde is phenylacetaldehyde.

10. An ink-jet receiving material comprising a support and at least one ink-receiving layer, said ink-receiving layer containing an inorganic pigment and a binder, wherein the binder is a water-soluble vinyl alcohol copolymer acetalized with a non-ionic aromatic aldehyde to a degree of acetalization of at most 15% by weight of non-ionic aromatic aldehyde with respect to the solid vinyl alcohol copolymer, characterized in that the ratio by weight of said inorganic pigment to said binder is at least 4/1.

11. An ink-jet receiving material according to claim 10, wherein said acetalized water-soluble vinyl alcohol copolymer is a vinyl alcohol copolymer acetalized with a non-ionic aromatic aldehyde to a degree of acetalization of between 3 and 8% by weight of non-ionic aromatic aldehyde with respect to the solid vinyl alcohol copolymer.

12. An ink-jet receiving material according to claim 10, wherein said non-ionic aromatic aldehyde is benzaldehyde.

13. An ink-jet receiving material according to claim 10, wherein said non-ionic aromatic aldehyde is phenylacetaldehyde.

14. An ink-jet receiving material according to claim 1, wherein said inorganic pigment is selected from the group consisting of silica, alumina, and boehmite.

15. An ink-jet receiving material according to claim 10, wherein said inorganic pigment is selected from the group consisting of silica, alumina, and boehmite.
